(19) United States
(12) Patent Application Publication
(10) Pub. No.: US 2025/0086780 A1
(43) Pub. Date: Mar. 13, 2025

(54) CONCENTRICITY OFFSET MEASUREMENT FOR HYBRID BONDING

(71) Applicant: KLA Corporation, Milpitas, CA (US)

(72) Inventors: Hemang Ashvinbhai Bhatt, Hillsboro, OR (US); Aravindh Vangal, Singapore (SG)

(21) Appl. No.: 18/827,828

(22) Filed: Sep. 8, 2024

Related U.S. Application Data
(60) Provisional application No. 63/537,887, filed on Sep. 12, 2023.

(51) Int. Cl. G06T 7/00; G06T 7/12

(52) U.S. Cl. CPC G06T 7/0006; G06T 7/12; G06T 2207/30148

(57) ABSTRACT

A metrology system is used to measure a bonded wafer with a top wafer disposed on a carrier wafer. An imaging system generates wafer edge profile images of a circumferential edge of the bonded wafer. The wafer edge profile images can be converted to greyscale. An edge of the bonded wafer can be determined in each of the wafer edge profile images. The pixels in the wafer edge profile images can be converted to a grid and an offset can be determined between the top wafer and carrier wafer.

### CROSS-REFERENCE TO RELATED APPLICATIONS

This application claims priority to the provisional patent application filed Sep. 12, 2023 and assigned U.S. App. No. 63/537,887, the disclosure of which is hereby incorporated by reference.

### FIELD OF THE DISCLOSURE

This disclosure relates to bonded wafer metrology.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Bonded (or stacked) wafers are frequently used in the semiconductor industry. One or more ultrathin wafers bonded to a carrier wafer is an example of a bonded wafer, though other semiconductor wafer designs also can be bonded wafers. For example, a bonded wafer can include a top wafer (e.g., a device wafer) bonded to a carrier wafer. These bonded wafers can be used for both memory and logic applications. Three-dimensional integrated circuits (3D IC) can be produced using bonded wafers.

Bonded wafers can have complex edge profiles. The various layers of a bonded wafer can have different heights and diameters. These dimensions can be affected by the size of the various wafers prior to stacking or by processing steps.

Bonded wafers with fabrication errors can cause problems during manufacturing. For example, centricity of the bonded wafer affects the CMP process or increases handling risks. During CMP, centricity affects placement of the polishing pad with respect to the center of the bonded wafer and subsequent planarization. During wafer handling, the balance of a bonded wafer or clearance within manufacturing equipment can be affected by centricity of the bonded wafer.

Concentricity measurement can ensure accurate alignment for optimal performance in hybrid bonding. As the interconnect density increases in microelectronic packages, the tolerances on concentricity may need resolution in the range of microns. Improper centricity can even ruin a bonded wafer or damage manufacturing equipment. If the bonded wafer is undercut, improperly bonded together, or contains too much glue, then the bonded wafer can break within the CMP tool, contaminating or damaging the CMP tool. Such contamination or damage leads to unwanted downtime or can even stop production within a semiconductor fab.

Furthermore, a CMP process on a bonded wafer with improper centricity can result in undesired edge profiles on the bonded wafer. For example, too much or not enough material may be removed during a CMP process or the CMP process may result in undercuts, overhangs, or whiskers. These undesired edge profiles can affect device yield or can impact later manufacturing steps.

It is difficult to measure offset in a bonded wafer. A wafer surface inspection tool or a wafer edge inspection tool module typically reports images of wafer periphery. This can use extrapolation and manual calculation based on a scale bar and field of view of the image, which may not be accurate or precise. There may be ten or more points to measure on each wafer, which can reduce throughput of the measurement process. Therefore, improved techniques for bonded wafer metrology and associated systems are needed.

### BRIEF SUMMARY OF THE DISCLOSURE

A metrology system is provided in a first embodiment. The metrology system includes a stage configured support a bonded wafer. The bonded wafer has a top wafer disposed on a carrier wafer. An imaging system is configured to generate wafer edge profile images of a circumferential edge of the bonded wafer. The imaging system includes a light source configured to generate collimated light and a detector configured to generate the wafer edge profile images. A processor is in electronic communication with the imaging system. The processor is programmed to: receive the wafer edge profile images; convert the wafer edge profile images from black and white to greyscale; determine an edge of the bonded wafer in each of the wafer edge profile images based on bright pixels and dark pixels in the wafer edge profile images; convert pixels of the edge in the wafer edge profile images to a dimension scale in a grid; and determine an offset between the top wafer and the carrier wafer.

The wafer edge profile images received by the processor may be shadowgram images.

The processor can be further configured to crop the wafer edge profile images prior to determining the boundary.

The grid may be a spreadsheet.

The wafer edge profile images may include from 20 to 30 of the wafer edge profile images for the bonded wafer.

A method is provided in a second embodiment. The method includes receiving wafer edge profile images of a bonded wafer at a processor. The bonded wafer has a top wafer disposed on a carrier wafer. The wafer edge profile images are converted from black and white to greyscale using the processor. An edge of the bonded wafer in each of the wafer edge profile images is determined using the processor based on bright pixels and dark pixels in the wafer edge profile images. The pixels of the edge in the wafer edge profile images are converted to a dimension scale in a grid using the processor. An offset between the top wafer and the carrier wafer is determined using the processor.

The wafer edge profile images received by the processor may be shadowgram images.

The method can include cropping the wafer edge profile images prior to determining the boundary.

The grid may be a spreadsheet.

The wafer edge profile images may include from 20 to 30 of the wafer edge profile images for the bonded wafer.

The method can include imaging a circumferential edge of the bonded wafer using an imaging system to generate the wafer edge profile images. The imaging system may include a light source configured to generate collimated light and a detector configured to generate the wafer edge profile images.

A non-transitory computer-readable storage medium is provided in a third embodiment. The non-transitory computer-readable storage medium comprises one or more programs for executing the following steps on one or more computing devices. Wafer edge profile images of a bonded wafer are received. The bonded wafer has a top wafer disposed on a carrier wafer. The wafer edge profile images are converted from black and white to greyscale. An edge of the bonded wafer is determined in each of the wafer edge profile images based on bright pixels and dark pixels in the wafer edge profile images. Pixels of the edge in the wafer edge profile images are converted to a dimension scale in a grid. An offset between the top wafer and the carrier wafer is determined.

The wafer edge profile images may be shadowgram images.

The steps may further include cropping the wafer edge profile images prior to determining the boundary.

The grid may be a spreadsheet.

The wafer edge profile images may include from 20 to 30 of the wafer edge profile images for the bonded wafer.

### DESCRIPTION OF THE DRAWINGS

For a fuller understanding of the nature and objects of the disclosure, reference should be made to the following detailed description taken in conjunction with the accompanying drawings, in which:

FIG. 1 shows an exemplary bonded wafer with a top view and two corresponding side views;

FIG. 2 is a block diagram with associated exemplary images of a method in accordance with the present disclosure;

FIGS. 3-4 are a top view and corresponding cross-sectional side view along A-A of a block diagram of a system in accordance with an embodiment of the present disclosure; and

FIG. 5 is a perspective view of a system corresponding to the embodiment of FIGS. 3-4.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

As part of 3D-integration process, semiconductor wafers can be stacked and bonded together. At least one top wafer, which may be a device wafer or some other type of wafer, is placed on a carrier wafer. The top wafer and the carrier wafer can be connected by an adhesive material. Several process parameters such as an amount of adhesive, force, temperature, wafer shape, and placement accuracy may cause a wafer displacement between the top wafer and the carrier wafer, such as the carrier wafer and the top wafer not being centered relative to each other. Methods and systems to measure wafer-to-wafer displacement of two or more wafers (e.g., top wafer and carrier wafer) in a bonded wafer are disclosed.

Embodiments disclosed herein can increase precision of alignment, assess bonding quality, optimize performance, enhance yield rates, and boost cost efficiency. Monitoring concentricity can allow manufacturers to achieve precision and reliability in hybrid device production. A user can report wafer trajectory at any circumferential position (theta) on a wafer and measure offsets across the wafers. Using wafer edge profile images, the image can be cropped to a region of interest and edge detection can be used to find edges. The edge points can be reported in a grid, such as a spreadsheet, for the user to track concentricity. For example, the grid can be a table with rows and columns. Embodiments disclosed herein can report data in user-readable format.

Concentricity measurement is used during a hybrid bonding processes, which can provide precise alignment and optimal performance of the bonded components. Hybrid bonding refers to a technique that combines different materials, such as silicon and glass, in microelectronic devices or integrated circuits. It creates a bond between the different layers or components to enable efficient signal transfer, thermal management, and device functionality. Hybrid bonding often requires precise alignment of various components, such as for electrodes, interconnects, or optical elements. Concentricity measurement can ensure that the alignment is accurate by evaluating the center-to-center positional relationship between these components. It helps to maintain the desired alignment tolerances, which ae can provide optimal performance and functionality of the hybrid device.

Concentricity measurement can provide feedback on the quality of the bonding process. It allows for the assessment of any misalignments or deviations from the desired position. By quantifying concentricity, it is possible to identify potential issues, such as lateral displacements or angular misalignments, which could affect the bonding strength or compromise the device's performance.

Hybrid bonding techniques can be used to enhance the overall performance of microelectronic devices. Concentricity measurement helps in optimizing this performance by ensuring that the bonded components are aligned with precision. This alignment can be used to achieve efficient signal transfer, minimize electrical losses, and maximize device functionality, especially in applications such as high-speed communication devices, sensors, or optoelectronics.

Concentricity measurement also plays a role in improving the yield and reliability of hybrid bonding processes. By accurately measuring concentricity, potential issues can be detected early in the manufacturing or assembly stages. This allows for timely adjustments, corrections, or even rejection of components that do not meet the required alignment criteria. By identifying and addressing alignment problems, yield rates can be improved, reducing the number of defective or non-functional devices. Effective concentricity measurement contributes to cost efficiency in hybrid bonding processes. By ensuring accurate alignment, the need for rework, component replacement, or additional manufacturing steps can be minimized. This helps to reduce overall production costs, improve manufacturing throughput, and increase the yield of functional devices.

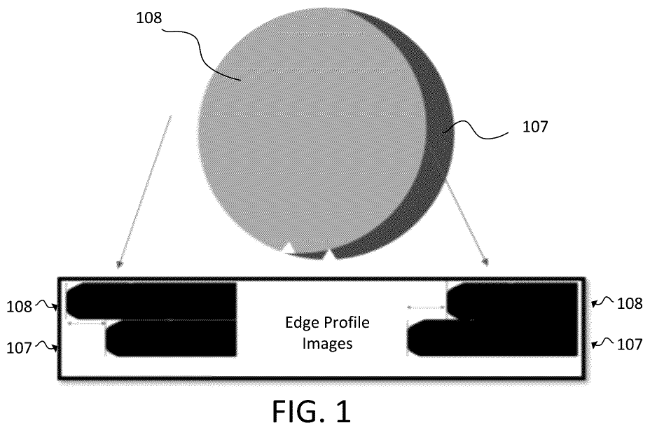

Wafer edge profile images can be acquired, such as using a system disclosed in U.S. Pat. No. 8,629,902, which is incorporated by reference in its entirety, or other systems. FIG. 1 is an exemplary wafer edge profile image of a circumferential edge of a bonded wafer having a carrier wafer 107 and a top wafer 108. The wafer edge profile images in FIG. 1 are examples of a shadowgram image. These exemplary profile images in FIG. 1 are from opposite sides of the bonded wafer (i.e., the right and left sides of the diagram as indicated by the arrows in FIG. 1).

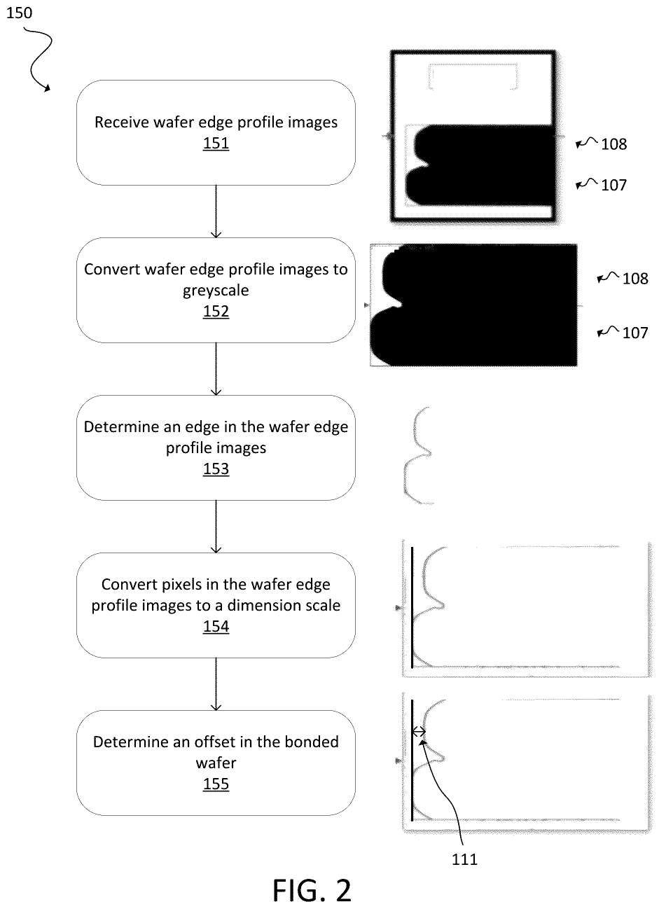

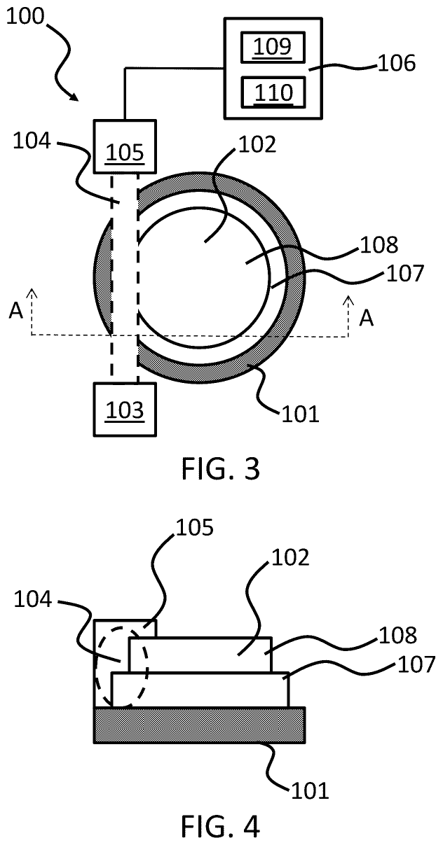

FIG. 2 shows a method 150. The steps of the method 150 can be performed using a processor. At 151, wafer edge profile images of a bonded wafer are received at a processor. As shown in FIG. 3 and the example on the right of FIG. 2, the bonded wafer has a top wafer 107 on a carrier wafer 108. The wafer edge profile images may be shadowgrams or other images. The wafer edge profile images may be exported from a wafer inspection tool, such as the system 100 shown in FIGS. 3-5.

Multiple wafer edge profile images for a bonded wafer can be provided. These wafer edge profile images can be at different points on the circumference of the bonded wafer. The points can be evenly spaced or selected by a user to be points of interest. In an example, there may be from 20-30 of the wafer edge profile images around a circumference of a bonded wafer.

Before further processing, the wafer edge profile images may be loaded from a directory, such as by using a Python script. Wafer edge profile images may be stored in a directory and may be sorted by wafer ID or lot ID. In an embodiment, wafer edge profile images can be grabbed automatically based on a folder, directory, or other storage location. In another embodiment, wafer edge profile images can be grabbed automatically subsequent to imaging.

Before further processing, the wafer edge profile images optionally may be cropped. This may occur between step 151 and step 152 or between step 152 and step 153. The images may be cropped based on the largest contour in the mask. The cropping can, for example, remove any text or extra data from the image. While cropping can help with certain images or can help a user visualize an image, cropping may not be necessary. The scripts involved in embodiments disclosed herein can operate without cropping.

To crop a wafer edge profile image, the image can be first thresholded to create a binary mask of the red boundary. Lower and upper bounds for the red color in the blue-green-red color space are defined. In an instance, a cv2.inRange function or another function can create a binary mask where the pixels within the specified red range are set to 255 (white) and all other pixels are set to 0 (black). Contours in the binary mask can then be determined. For example, cv2.RETR_EXTERNAL retrieves the outermost contours and cv2.CHAIN_APPROX_SIMPLE compresses horizontal, vertical, and diagonal segments, which leaves only their end points. A bounding box of the largest contour is then determined. The largest contour may be based on the contour area and then the bounding box can be determined for this contour. The bounding box may be defined by its top-left corner (x, y) and its width w and height h. Finally, the portion of the image within the bounding box can be cropped. The original image may be cropped. The cropped image can replace the original image or can be saved as a new file. In the example of FIG. 2, the rectangle above the image of the bonded wafer may contain text and can be cropped.

At 152, the wafer edge profile images are converted from black and white to greyscale. Modules such as the Python module “Pillow” can be used. Python modules such as the average method (gray=(img[ . . . , 0]+img[ . . . , 1]+img[ . . . , 2])/3); luminosity method (gray=0.2989*img[ . . . , 0]+0.5870*img[ . . . , 1]+0.1140*img[ . . . , 2]), lightness method (gray=(np.max(img[ . . . ,: 3], axis=2)+np.min(img[ . . . ,: 3], axis=2))/2), single color channel method (gray=img[ . . . , 0] # Using the red channel), or other techniques can be used.

While optional, use of greyscale can improve the techniques disclosed herein. Greyscale images have only one channel (intensity) compared to three channels (red, green, blue) in color images. This simplification reduces the computational complexity and makes the edge detection process more efficient. Edge detection algorithms like Canny are designed to work on intensity gradients. In a grayscale image, the intensity values range from 0 (black) to 255 (white), providing a uniform scale for detecting edges. Color images, on the other hand, have varying intensity values across different channels, which can complicate the edge detection process. Greyscale conversion may help reduce the noise that might be present in different color channels. Noise can lead to false edges being detected. The Canny edge detection algorithm also relies on calculating the gradient of the image intensity to find edges. In a greyscale image, the gradient calculation is straightforward as it involves only one channel. In a color image, gradients are calculated for each channel and then combined, which can be more complex and less effective. Furthermore, using a single intensity channel ensures that the edge detection is consistent across the entire image. In color images, edges might appear differently in different channels, leading to inconsistent edge detection results.

At 153, an edge of the bonded wafer can be determined in each of the wafer edge profile images. This can be based on bright pixels and dark pixels in the respective wafer edge profile images. For example, Canny edge detection can be used to separate bright and dark pixels and provide a sharp boundary between the bonded wafer and non-wafer areas. While Canny edge is disclosed, other algorithms can be used. For example, a Sobel operator can be used. The Sobel operator uses two 3×3 kernels to calculate the gradient of the image intensity in the x and y directions. In another example, a Prewitt operator can be used. Similar to the Sobel operator, the Prewitt operator uses two 3×3 kernels to approximate the gradient of the image intensity. It may be slightly less sensitive to noise compared to the Sobel operator. In another example, a Roberts Cross operator can be used. The Roberts Cross operator uses two 2×2 kernels to calculate the gradient of the image intensity, which can be more sensitive to noise. In another example, a Laplacian of Gaussian (LoG) operator can be used. The LoG operator applies a Gaussian filter to smooth the image and then applies the Laplacian operator to detect edges. This reduces noise before edge detection. In another example, a Difference of Gaussian (DoG) operator can be used. The DoG operator subtracts one blurred version of an image from another, which helps in detecting edges by highlighting regions with high spatial frequency. In another example, a Scharr operator can be used. The Scharr operator is an improvement over the Sobel operator, providing better rotational symmetry and more accurate edge detection.

Canny edge detection is an edge detection operator that can use a multi-stage algorithm to detect edges in images. In an instance, Canny edge detection applies a Gaussian filter to smooth the image to remove noise, finds the intensity gradients of the image, applies gradient magnitude thresholding or lower bound cut-off suppression to remove spurious response to edge detection, applies a double threshold to determine potential edges, and tracks an edge by hysteresis. The edges may be detected by suppressing all the edges that are weak and not connected to strong edges.

At 154, the pixels of the edge of the wafer edge profile images can be converted to a dimension scale in a grid. The grid may be a spreadsheet, such as an Excel spreadsheet. This can provide a readable file. In an instance, one pixel is 2.4 microns, so the pixels can be converted to a dimension scale using this relationship. The microns per pixel may be a specification for the wafer inspection tool. In an embodiment to convert to a spreadsheet, the edge points are found and converted to pixel values. For example, an np.nonzero (edges) function returns the indices of the non-zero elements in the edges array, which correspond to the edge points detected in the image. An np.transpose ( . . . ) function transposes the array of indices so that each row represents an edge point with its (row, column) coordinates. Edge points are converted to microns and a DataFrame is created, which can be a two-dimensional data structure like an array or table with rows and columns. An edge_points*2.4 function scales the pixel coordinates by a factor of 2.4 to convert them to microns. Apd.DataFrame( . . . , columns=[‘X’, ‘Y’]) function creates a DataFrame from the scaled edge points, with columns named ‘X’ and ‘Y’. The edge points are then saved to a spreadsheet or other grid. An edge_points_df.to_excel( . . . ) function saves the DataFrame to an Excel file at the specified path. An index=False parameter may ensure that the DataFrame index is not written to the Excel file or other spreadsheet file. Thus, embodiments disclosed herein can find the edge points in an image, convert their coordinates from pixels to microns, store them in a DataFrame, and then save this DataFrame to an Excel file or other spreadsheet.

An offset in the bonded wafer can be determined at 155. This offset can measure the difference between and edge of the top wafer and an edge of the carrier wafer. In the grid (e.g., spreadsheet), the wafer trajectory can be plotted. Offset can be measured at any selected point. Wafer concentricity of a bonded wafer can be determined. Wafer trajectory at any point theta on a circumference of the bonded wafer can be reported. Concentricity can be measured to quantify bonding quality. A wafer edge model for a specific bonded wafer is not needed. Thus, the wafer design for a bonded wafer is not required to determine concentricity. In the example of FIG. 2, the distance represented by the line 111 can show the offset. The offset at different points theta along the circumference of the bonded wafer can be compared to determine a total offset or a relationship between the top wafer 108 and the carrier wafer 107.

In an embodiment, edge points are reported in a spreadsheet in two columns. The X column represents wafer thickness which can range from 0 to 1600 micron while the Y column represents an edge of wafer derived from Canny edge detection algorithm or other technique to determine the edge. A user can plot an X,Y scatter plot, which can provide the wafer surface on graph. The difference can be determined by checking the distance on the spreadsheet between these points.

In an instance, a user can draw a scatter chart or plot to determine wafer trajectory on a micron scale. A user can measure an offset between the top wafer and the carrier wafer at any selected point on the image and any point theta on the bonded wafer.

In an embodiment, the entire script of the method 150 uses an OpenCV library for image processing. NumPy can be used for array operations. Pandas can be used to create a DataFrame and export the data into a spreadsheet. Cropping can be performed using a Python script. Other programming languages or scripts can be used for these functions or other functions of the method 150.

In an embodiment, the results of the method 150 can be exported to a data format, such as the KLARF format used by KLA Corporation.

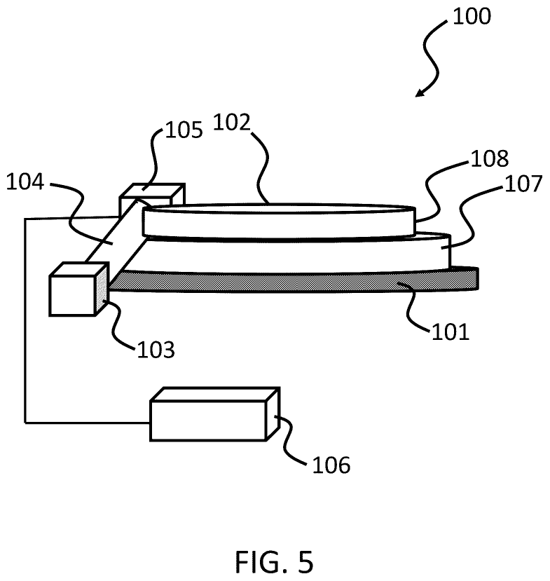

FIGS. 3-4 are a top view and corresponding cross-sectional side view along A-A of a block diagram of a system 100 in accordance with an embodiment of the present disclosure. FIG. 5 is a perspective view of a system 100 corresponding to the embodiment of FIGS. 3-4. System 100 is configured to perform metrology of a bonded wafer by acquiring images that are shadowgrams. A shadowgram applies a shadowgraph technique and visualizes or images a shadow of the bonded wafer 102, such as a circumferential edge of the bonded wafer 102. A stage 101 can be configured to rotate a bonded wafer 102, though the system 100 also can rotate with respect to the bonded wafer 102. Such rotation can be stepped or continuous. The bonded wafer 102 also may not rotate during imaging and components of the system 100 may be fixed.

The exemplary bonded wafer 102 is shown with a carrier wafer 107 and a top wafer 108. The carrier wafer 107 and top wafer 108 may have different diameters, such as those illustrated in FIG. 1. For example, the carrier wafer 107 can be a carrier wafer and the top wafer 108 can be a device wafer. Alternatively, the carrier wafer 107 and top wafer 108 can both be device wafers or more than the carrier wafer 107 and top wafer 108 can form the bonded wafer 102.

A light source 103 is configured to direct collimated light 104 at an edge of the bonded wafer 102. In some embodiments, the collimated light 104 is directed tangentially, with respect to the bonded wafer 102, so as to create a shadow of the edge profile. Thus, the bonded wafer 102 blocks some of the collimated light 104. The collimated light 104 is illustrated as approximately circular, but also can be other shapes. In an exemplary embodiment, the light source 103 uses a light-emitting diode (LED). Other suitable light sources 103, such as a lamp that produces collimated light, laser, supercontinuum laser, laser-driven phosphor, or laser-driven lamp, will be apparent in light of the present disclosure. Combinations of light sources 103, such as a laser and an LED, may be utilized. The light source 103 can include both single band and broadband light sources in a single system or multiple systems. The collimated light 104 may be parallel to a plane of the bonded wafer 102. For example, the collimated light 104 may be parallel to the plane of the carrier wafer 107 on which the top wafer 108 is disposed. Diffraction suppression techniques may be used to remove diffraction-related artifacts that may adversely affect measurements. Approximately a few millimeters of the bonded wafer 102 are seen in a profile using the collimated light 104, though other dimensions are possible.

A detector 105 located apart from the light source 103 receives at least some of the collimated light 104. The detector 105 is located such that when a bonded wafer 102 is being imaged, at least a portion of the shadow (i.e., the light producing the shadow) is received by the detector 105. The detector 105 can be, for example, a charge-coupled device (CCD) or complementary metal-oxide-semiconductor (CMOS) camera. In this way, an image of the wafer edge silhouette is formed (i.e., a wafer edge profile image). The detector 105 can be configured to collect hundreds of wafer edge profile images of the bonded wafer 102 for high sampling. For example, between 2 and 500 wafer edge profile images of the bonded wafer 102 may be collected at various points theta around a circumference of the bonded wafer 102, though more images can be collected. In an example, 16 wafer edge profile images of a bonded wafer are collected. In another example, 20 wafer edge profile images of a bonded wafer 102 are collected. In another example, 30 wafer edge profile images of a bonded wafer 102 are collected. In another example, 36 wafer edge profile images of a bonded wafer 102 are collected. In another example, 360 wafer edge profile images of a bonded wafer 102 are collected.

The collimated light 104 may have a wavelength or wavelengths that produce a shadow. For example, visible light such as blue light or white light may be used. Other suitable collimated light 104 will be apparent in light of the present disclosure. For example, ultraviolet light can be used. The collimated light 104 may be polarized and may be pulsed or continuous.

While only a single light source 103 and detector 105 are illustrated in FIGS. 3-5, multiple light sources 103 and detectors 105 may be used. Multiple light sources 103 and detectors 105 may be placed at various locations around the perimeter of the bonded wafer 102 to collect images at different locations of the bonded wafer 102. This may increase inspection throughput or increase the number of images produced while minimizing the impact to inspection throughput. If multiple light sources 103 and detectors 105 are placed at various locations around the perimeter of the bonded wafer 102, then the bonded wafer 102 may not rotate with respect to the light source 103 or detector 105.

A controller 106 is operatively connected to the detector 105. The controller 106 is configured to analyze an image of the edge of the bonded wafer 102 and can control the acquisition of the images using the detector 105. For example, the controller 106 can rotate the bonded wafer 102 with respect to the light source 103 or detector 105. The controller 106 also can control the timing or locations of image acquisition on the bonded wafer 102. The controller 106 may be configured to perform other functions or additional steps using the output of the detector 105. For example, the controller 106 may be programmed to perform some or all of the steps of FIG. 2. The controller 106 can include a processor 109 and a memory 110.

The controller 106, other system(s), or other subsystem(s) described herein may take various forms, including a personal computer system, workstation, image computer, mainframe computer system, workstation, network appliance, internet appliance, parallel processor, or other device. In general, the term “controller” may be broadly defined to encompass any device having one or more processors that executes instructions from a memory medium. The subsystem(s) or system(s) may also include any suitable processor known in the art, such as a parallel processor. In addition, the subsystem(s) or system(s) may include a platform with high-speed processing and software, either as a standalone or a networked tool.

If the system includes more than one subsystem, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

In another embodiment, the controller 106 may be communicatively coupled to any of the various components or sub-systems of system 100 in any manner known in the art. Moreover, the controller 106 may be configured to receive and/or acquire data or information from other systems by a transmission medium that may include wireline and/or wireless portions. In this manner, the transmission medium may serve as a data link between the controller 106 and other subsystems of the system 100 or systems external to system 100.

An additional embodiment relates to a non-transitory computer-readable medium storing program instructions executable on a controller for performing a computer-implemented method for bonded wafer metrology, such as for performing the techniques disclosed herein. In particular, as shown in FIG. 3, the controller 106 can include a memory 110 or other electronic data storage medium with non-transitory computer-readable medium that includes program instructions executable on the controller 106. The computer-implemented method may include any step(s) of any method(s) described herein, such as that disclosed with respect to FIG. 2. The memory 110 or other electronic data storage medium may be a storage medium such as a read-only memory, a random-access memory, a magnetic or optical disk, a non-volatile memory, a solid-state memory, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), SSE (Streaming SIMD Extension), or other technologies or methodologies, as desired.

In some embodiments, various steps, functions, and/or operations of system 100 and the methods disclosed herein are carried out by one or more of the following: electronic circuits, logic gates, multiplexers, programmable logic devices, application-specific integrated circuits (ASICs), analog or digital controls/switches, microcontrollers, or computing systems. Program instructions implementing methods such as those described herein may be transmitted over or stored on carrier medium. A carrier medium may include an electronic data storage medium, such as that of the memory 110, or a transmission medium such as a wire, cable, or wireless transmission link. For instance, the various steps described throughout the present disclosure may be carried out by a single controller 106 (or computer system) or, alternatively, multiple controllers 106 (or multiple computer systems). Moreover, different sub-systems of the system 100 may include one or more computing or logic systems. Therefore, the above description should not be interpreted as a limitation on the present invention but merely an illustration.

As used throughout the present disclosure, a “wafer” may refer to a substrate formed of a semiconductor or non-semiconductor material. For example, a semiconductor or non-semiconductor material may include, but is not limited to, monocrystalline silicon, gallium arsenide, or indium phosphide. A wafer may include one or more layers. For example, such layers may include, but are not limited to, a resist, a dielectric material, a conductive material, or a semiconductive material. Many different types of such layers are known in the art, such as, but not limited to, isolation layers, implantation layers, and the like. The term “wafer” as used herein is intended to encompass a substrate on which any of such layers may be formed.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed

What is claimed is:

1. A metrology system comprising:
a stage configured support a bonded wafer, wherein the bonded wafer has a top wafer disposed on a carrier wafer; and
an imaging system configured to generate wafer edge profile images of a circumferential edge of the bonded wafer, wherein the imaging system includes a light source configured to generate collimated light and a detector configured to generate the wafer edge profile images; and
a processor in electronic communication with the imaging system, wherein the processor is programmed to:
receive the wafer edge profile images;
convert the wafer edge profile images from black and white to greyscale;
determine an edge of the bonded wafer in each of the wafer edge profile images based on bright pixels and dark pixels in the wafer edge profile images;
convert pixels of the edge in the wafer edge profile images to a dimension scale in a grid; and
determine an offset between the top wafer and the carrier wafer.

2. The metrology system of claim 1, wherein the wafer edge profile images received by the processor are shadowgram images.

3. The metrology system of claim 1, wherein the processor is further configured to crop the wafer edge profile images prior to determining the boundary.

4. The metrology system of claim 1, wherein the grid is a spreadsheet.

5. The metrology system of claim 1, wherein the wafer edge profile images include from 20 to 30 of the wafer edge profile images for the bonded wafer.

6. A method comprising:
receiving wafer edge profile images of a bonded wafer at a processor, wherein the bonded wafer has a top wafer disposed on a carrier wafer;
converting the wafer edge profile images from black and white to greyscale using the processor;
determining an edge of the bonded wafer in each of the wafer edge profile images using the processor based on bright pixels and dark pixels in the wafer edge profile images;
converting pixels of the edge in the wafer edge profile images to a dimension scale in a grid using the processor; and
determining an offset between the top wafer and the carrier wafer using the processor.

7. The method of claim 6, wherein the wafer edge profile images received by the processor are shadowgram images.

8. The method of claim 6, further comprising cropping the wafer edge profile images prior to determining the boundary.

9. The method of claim 6, wherein the grid is a spreadsheet.

10. The method of claim 6, wherein the wafer edge profile images include from 20 to 30 of the wafer edge profile images for the bonded wafer.

11. The method of claim 6, further comprising imaging a circumferential edge of the bonded wafer using an imaging system to generate the wafer edge profile images, wherein the imaging system includes a light source configured to generate collimated light and a detector configured to generate the wafer edge profile images.

12. A non-transitory computer-readable storage medium, comprising one or more programs for executing the following steps on one or more computing devices:
receive wafer edge profile images of a bonded wafer, wherein the bonded wafer has a top wafer disposed on a carrier wafer;
convert the wafer edge profile images from black and white to greyscale;
determine an edge of the bonded wafer in each of the wafer edge profile images based on bright pixels and dark pixels in the wafer edge profile images;
convert pixels of the edge in the wafer edge profile images to a dimension scale in a grid; and
determine an offset between the top wafer and the carrier wafer.

13. The transitory computer-readable storage medium of claim 12, wherein the wafer edge profile images are shadowgram images.

14. The transitory computer-readable storage medium of claim 12, wherein the steps further include cropping the wafer edge profile images prior to determining the boundary.

15. The transitory computer-readable storage medium of claim 12, wherein the grid is a spreadsheet.

16. The transitory computer-readable storage medium of claim 12, wherein the wafer edge profile images include from 20 to 30 of the wafer edge profile images for the bonded wafer.
